(19) United States
(12) Patent Application Publication
(10) Pub. No.: US 2010/0198461 A1
(43) Pub. Date: Aug. 5, 2010

(54) METHOD AND APPARATUS FOR CONTROLLING AN ELECTRIC ASSIST MOTOR USING A MODIFIED BLENDING FILTER

(75) Inventors: Anthony Walter Burton, Birmingham (GB); Angel Luis Andres Fernandez, Birmingham (GB); Axel De Pascal, Paris (FR)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: TRW LUCASVARITY ELECTRIC STEERING LIMITED, West Midlands (GB)

(21) Appl. No.: 12/695,702

(22) Filed: Jan. 28, 2010

Related U.S. Application Data
(63) Continuation of application No. 11/046,182, filed on Jan. 28, 2005, now abandoned.

(30) Foreign Application Priority Data
Jan. 30, 2004 (GB) GB0401965.9

(51) Int. Cl. G06F 19/00

(52) U.S. Cl. 701/41

(57) ABSTRACT

A method for controlling an electric assist motor for providing steering assist in response to a sensed torque signal includes the step of filtering the sensed torque signal to provide a low frequency torque signal and a high frequency torque signal. A low frequency assist torque signal is determined as a function of the low frequency torque signal. A high frequency assist gain signal is determined as a function of the sensed torque signal and a sensed vehicle speed. The high frequency assist gain signal is applied to the high frequency torque signal to determine a high frequency assist torque signal. A torque command signal is determined as a function of the low frequency assist torque signal and the high frequency assist torque signal. The electric assist motor is commanded to provide steering assist in accordance with the torque command signal.

### CROSS-REFERENCE TO RELATED APPLICATIONS

This application is a continuation of United Kingdom Patent Application No. 0401965.9 filed Jan. 30, 2004, the disclosures of which are incorporated herein by reference.

### BACKGROUND OF THE INVENTION

The present invention is directed to a method and apparatus for controlling an electric assist motor. In particular, the present invention is directed to a method and apparatus for controlling an electric motor of an electric assist steering system using a modified blending filter.

Electric assist steering systems are well known in the art. In such electric assist steering systems, an electric assist motor, when energized, provides steering assist torque to aid the driver in turning steerable wheels of the vehicle. The electric assist motor is typically controlled in response to both steering torque applied to the vehicle steering wheel and measured vehicle speed. A controller monitors steering torque and controls a drive circuit which, in turn, supplies electric current to the electric assist motor. Such drive circuits typically include field affect transistors (“FETs”) or other forms of solid state switches operatively coupled between the vehicle battery and the electric assist motor. Motor current is controlled by pulse width modulation (“PWM”) of the FETs.

On-center feel is defined as the responsiveness of the steering system for a vehicle traveling in a substantially straight line. Good on-center feel occurs when the driver senses the vehicle lateral acceleration for small steering wheel angle inputs and when the vehicle travels in a straight line with minimal input from the driver. A vehicle that tends to wander or drift from the desired straight line is considered to have poor on-center feel.

Off-center feel is the responsiveness of the steering system in a steady state turn. Good off-center feel occurs when the driver, while in a steady state turn at a high vehicle speed, e.g., on a curved entrance ramp onto a freeway, can easily make small changes in the steering wheel angle that clearly modify the vehicle path. If the angular corrections are difficult to make due to high friction or hysteresis, or if the corrections do not causally modify the vehicle's path, the vehicle is characterized as having poor off-center feel.

At high vehicle speeds, it is desirable to provide good off-center response as well as good on-center feel. To accomplish this, a trade-off is made in selection of the torque signal to obtain acceptable on-center feel and off-center responsiveness.

Known electric assist steering systems have a dynamic performance characteristic, i.e., system bandwidth, that varies as a function of vehicle speed. As the vehicle operator applies steering torque and rotates the steering wheel back-and-forth, the electric assist motor is energized to provide steering assist in response to the sensed steering inputs. The response of the steering system at a particular frequency of back-and-forth steering wheel movement is indicative of the system's dynamic performance. The frequency range over which the steering system satisfactorily responds is the system's bandwidth.

The amount of local change at the electric assist motor divided by the amount of local change in steering torque applied by the driver is the steering system gain. Due to the control function of processing the sensed torque into a desired motor command, a time delay occurs from the time steering torque is applied to the steering wheel to the time the assist motor responds. This time delay is a function of the frequency at which the input command is applied. This is referred to as the system response time. The system gain is set to a predetermined value so as to have a short system response time while still maintaining overall system stability. The system response time and system gain are factors in the steering system bandwidth.

The bandwidth of a steering system varies as a function of vehicle speed. If dynamic steering frequency or the frequency of a transient steering input in an electric assist steering system exceeds the system bandwidth at a particular vehicle speed, the steering feel becomes “sluggish” (felt as a “hesitation” to a steering input) since the steering assist motor can not respond quick enough. Steering system gain as well as system bandwidth decreases in an electric assist steering system as the vehicle speed increases resulting in system hesitation or sluggishness becoming more noticeable as vehicle speed increases.

### BRIEF SUMMARY OF THE INVENTION

The present invention provides a method and apparatus for improving the steering feel in an electric motor in an electric assist steering system. A high frequency assist gain value is determined in response to vehicle speed and applied steering torque. The high frequency assist gain value is used to control a torque command value so as to provide good off-center tracking as well as good on-center feel.

The present invention is directed to a method for controlling an electric assist motor for providing steering assist in response to a sensed torque signal. The method comprises the step of filtering the sensed torque signal τₛ to provide a low frequency torque signal τ_{sL} and a high frequency torque signal τ_{sH}. A low frequency assist torque signal τ_{assistLF} is determined as a function of the low frequency torque signal τ_{sL}. A high frequency assist gain signal Kₘₐₓ is determined as a function of the sensed torque signal τₛ and a sensed vehicle speed v. The high frequency assist gain signal Kₘₐₓ is applied to the high frequency torque signal τ_{sH} to determine a high frequency assist torque signal τ_{assistHF}. A torque command signal τ_{cmd} is determined as a function of the low frequency assist torque signal τ_{assistLF} and the high frequency assist signal τ_{assistHF}. The electric assist motor is commanded to provide steering assist in accordance with the torque command signal τ_{cmd}.

The present invention is also directed to an apparatus for controlling a vehicle electric assist steering motor. The apparatus includes a vehicle speed sensor that provides a speed signal having a value indicative of sensed vehicle speed. An applied steering torque sensor provides a sensed torque signal indicative of the applied steering torque. The apparatus also includes filtering means that filters the sensed torque signal to provide a low frequency torque signal and a high frequency torque signal; means for determining a low frequency assist torque value as a function of the low frequency torque signal provides a low frequency assist torque signal; means for determining a high frequency assist gain value as a function of the sensed torque signal and a sensed vehicle speed provides a high frequency assist gain signal; means for determining a high frequency assist torque value related to the product of the high frequency torque signal and the high frequency assist gain signal and providing a high frequency assist torque signal; means for determining a torque command value as a function of the low frequency assist torque signal and the high frequency assist torque signal to provide a torque command signal; and motor commanding means which command the electric assist motor to provide steering assist in accordance with the torque command signal.

Preferably, said step of determining a high frequency assist gain signal comprises the steps of:

determining a low vehicle speed high frequency assist gain as a function of said sensed torque signal;

determining a high vehicle speed high frequency assist gain as a function of said sensed torque signal; and

blending said low vehicle speed high frequency assist gain and said high vehicle speed high frequency assist gain as a function of vehicle speed.

Preferably, the blending of said low-speed high frequency assist gain and said high-speed high frequency assist gain is based on a 2D map in dependence upon vehicle speed and steering input torque.

More preferably, said step of blending said low-speed high frequency assist gain and said high speed high frequency assist gain comprises the steps of:

establishing a 2D map whose inputs are vehicle speed and low frequency input torque and whose output is high frequency gain;

determining a blended low-speed high frequency assist gain as the product of said low speed high frequency assist gain and said high frequency gain;

determining a blended high-speed high frequency assist gain as the product of said high-speed high frequency assist gain and the difference between one and said high frequency gain; and

determining the sum of said blended low-speed high frequency assist gain and said blended high-speed high frequency assist gain.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic representation of an electric assist steering system in accordance with one embodiment of the present invention;

FIG. 2 is a functional block diagram of a torque control loop of the electric assist steering system of FIG. 1;

FIG. 3 is a functional block diagram of a low frequency assist curve function of FIG. 2;

FIG. 4 is a graph illustrating high frequency assist curves of a high frequency assist gain computation function of FIG. 2;

FIG. 5 is a functional block diagram of the high frequency assist gain computation function of FIG. 2;

FIG. 6 is a graph illustrating a speed proportional gain curve used by the high frequency assist gain computation function of FIG. 2;

FIG. 7 shows an alternative high frequency assist gain computation function;

FIG. 8 shows an example of a 2D map; and

FIG. 9 shows the overall system when modified as shown in FIG. 7.

### DETAILED DESCRIPTION OF THE INVENTION

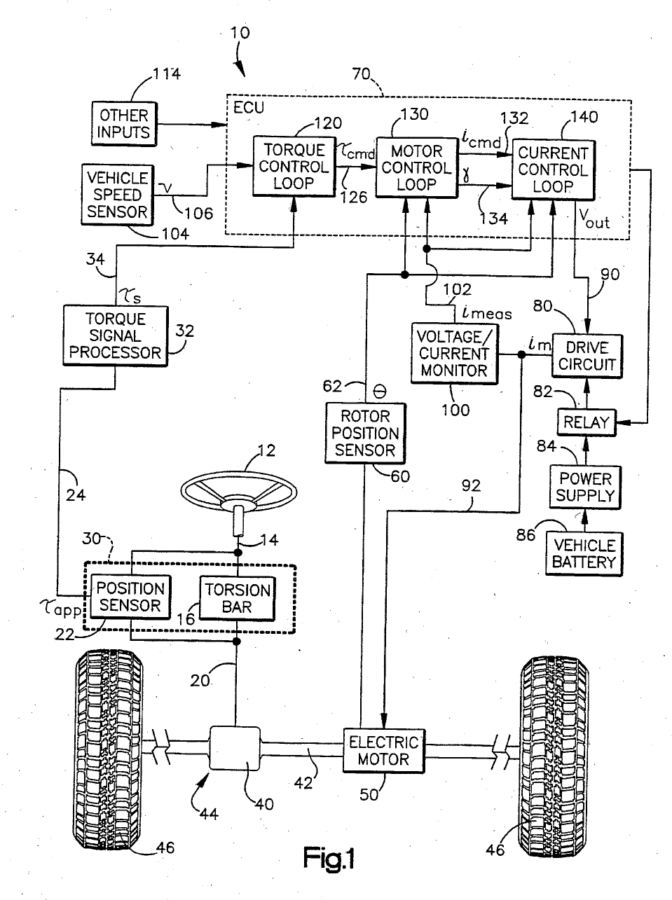

Referring to FIG. 1, an electric assist steering system 10 includes a steering wheel 12 connected to an input shaft 14. The input shaft (14) is operatively connected to an output shaft 20 through a torsion bar 16. The torsion bar 16 twists in response to applied steering torque thereby permitting relative rotation between the input shaft 14 and the output shaft 20. Stops (not shown) limit the amount of relative rotation between the input and output shafts 14 and 20 in a manner known in the art. The torsion bar 16 has a spring constant, referred to herein as Kₜ. The amount of applied steering torque as a function of relative rotational movement between the input shaft 14 and the output shaft 20 in response to applied steering torque is a function of Kₜ. The spring constant Kₜ may be expressed in units of Newton Meters (N·M) or in-lbs. per degree of rotation between the input shaft 14 and the output shaft 20.

A position sensor 22 is operatively connected to the input shaft 14 and to the output shaft 20. The position sensor 22 in combination with the torsion bar 16 forms a torque sensor 30. The position sensor 22 determines the relative rotational position between the input shaft 14 and the output shaft 20. The torque sensor 30 provides an applied torque signal τₐₚₚ, indicated at 24, to a torque signal processor 32. The applied torque signal τₐₚₚ is indicative of the relative rotational position between the input shaft 14 and the output shaft 20.

When the steering wheel 12 is rotated, the relative angle between the input shaft 14 and the output shaft 20 varies as a function of the input torque applied to the steering wheel. The torque signal processor 32 monitors the angle between the input shaft 14 and the output shaft 20 via the applied torque signal τₐₚₚ and, given the spring constant Kₜ of the torsion bar 16, provides a signal, shown at 34, indicative of the applied steering torque Tₛ.

The output shaft 20 is connected to a pinion gear 40. The pinion gear 40, as is well known in the art, has helical teeth that engage or mesh with straight cut teeth on a steering rack or linear steering number 42. The pinion gear 40 in combination with the gear teeth on the steering rack 42 form a rack and pinion gear set 44. The steering rack 42 is operatively coupled to the vehicle's steerable wheels 46 via steering linkage (not shown) in a known manner. When the steering wheel 12 is turned, the rack and pinion gear set 44 converts the rotary motion of the steering wheel 12 into linear motion of the steering rack 42. When the steering rack 42 moves in a linear direction, the steerable wheels 46 pivot about their associated steering axes.

According to the example embodiment, an electric assist motor 50 is operatively connected to the steering rack 42 through a ball-nut assembly (not shown) in a known manner or other desired gearing arrangement (such as a worm and wheel, bevel gear or belt driven system). For the purpose of an explanation of an exemplary embodiment of the present invention, it is assumed that the operative connection of the electric motor to the steering nut is made through a ball nut assembly, although the present invention is equally applicable to other arrangements which operatively connect the electric motor to the steering gear. Those skilled in the art will recognize that the electric assist motor 50 may have an alternative connection to the steering members for the purpose of providing steering assist. For example, the electric assist motor 50 could be operatively connected to the output shaft 20, to a separate pinion drive arrangement, etc. When energized, the electric assist motor 50 provides power assist to aid in the rotation of the vehicle steering wheel 12 by the vehicle operator.

The electric motor 50 of the example embodiment may be of any known type suitable for use in the electric assist steering system 10. For example, the electric motor 50 may be a variable reluctance (“VR”) motor, a permanent magnet alternating current (“PMAC”) motor or a brushless direct current (“BLDC”) motor. In the example embodiment, the electric motor 50 is described herein as having the specific purpose of providing power assist in the electric assist steering system 10. The present invention is equally applicable to other motor configurations and other motor purposes such as providing mechanical power for machine tools.

The basic operation of an electric assist motor in an electric assist steering system 10 is well known in the art. Basically, the stator poles are energized to achieve a desired amount of motor torque in a desired rotational direction. The direction of motor rotation is controlled in response to the sequence in which the stator coils are energized in certain motor types and the direction of current flow in other motor types. The torque produced by the motor is controlled by the amount of current through the stator coils. For the purpose of explanation of an exemplary embodiment of the present invention, it is assumed that the electric assist motor 50 is a PMAC motor.

When the electric motor 50 is energized, the motor rotor turns which, in turn, rotates the nut portion of the ball-nut drive arrangement to which the rotor is connected. When the nut rotates, the balls transfer a linear force to the steering rack 42. The direction of movement of the steering rack 50 is dependent upon the direction of rotation of the electric motor 50.

A rotor position sensor 60 is operatively connected to the motor 50 and senses the position of the rotor relative to the stator. The position sensor 60 provides a rotor position signal θ, indicated at 62, having a value indicating that relative position between the rotor and the stator. The structure and operation of a rotor position sensor is known in the art and, therefore, is not described herein in detail. It is necessary to know the position of the rotor relative to the stator to achieve the desired rotational direction and output torque of the electric motor 50.

The electric assist steering system 10 includes an electronic control unit (ECU) 70. The ECU 70 is preferably a microcomputer having suitable memory. It will be appreciated that the ECU 70 may have other suitable configurations. The ECU 70 is programmed with control algorithms that are operative to control the electric motor 50 in a predetermined manner in response to sensed parameters.

The ECU 70 is operatively connected to a drive circuit 80. The drive circuit 80 is operatively connected to a power supply 84 via a relay 82. The power supply 84 is operatively connected to a vehicle battery 86 and regulates electrical power supplied to the drive circuit 80. The ECU 70 provides a voltage control output signal vₒᵤₜ, indicated at 90, to the drive circuit 80. The voltage control output signal vₒᵤₜ is indicative of the voltage to be supplied to each phase of the electric motor 50, as determined by the control algorithms programmed in the ECU 70 and described below in detail.

The drive circuit 80 includes FETs or other suitable forms of controllable solid state switches that are operative to provide motor current iₘ, indicated at 92, to the phases of the electric motor 50. Motor current iₘ for each phase of the electric motor 50 is controlled by PWM of the FETs in accordance with the voltage control output signal vₒᵤₜ.

A voltage/current monitoring device 100 monitors the motor current iₘ provided to the electric motor 50 and provides a measured motor current signal iₘₑₐₛ of each phase to the ECU 70. These measured motor current signals iₘₑₐₛ are indicated at 102. The rotor position sensor 60 and the torque signal processor 32 provide the rotor position θ signal and the sensed torque signal, respectively, to the ECU 70. A vehicle speed sensor 104 provides a vehicle speed signal v, indicated at 106, to the ECU 70. Other inputs, indicated generally at 114, may also be provided to the ECU 70 for control, safety, or system monitoring purposes.

The control algorithms stored in the ECU 70 comprise a torque control loop 120, a motor control loop 130, and a current control loop 140. The torque control loop 120 is operative to determine a requested torque command signal τ_{cmd}, indicated at 126. The torque command signal τ_{cmd} is indicative of the amount of steering assist torque required from the electric motor 50, based at least partially on the sensed steering applied torque τₛ and the sensed vehicle speed v. The torque control loop 120 provides the torque command signal τ_{cmd} to the motor control loop 130.

The motor control loop 130 is operative to determine a motor current command i_{cmd}, indicated at 132, and a dq current advance angle γ, indicated at 134. A dq current control loop is used to control the current in the electric motor 50. The current command signal i_{cmd} indicates the amount of current to be supplied to the electric motor 50. The dq current advance angle γ indicates: rotational angle of the motor current with respect to the q-axis to which the motor is to be commanded. The dq-current advance angle γ is determined as a function of motor speed and is non-zero only for high motor speeds. The current command signal i_{cmd} and the dq current advance angle γ are determined based on the torque command τ_{cmd} and the sensed rotor velocity ω. The measured motor current iₘₑₐₛ and the sensed rotor position θ are provided to the motor control loop 130 for feedback and monitoring purposes. The motor control loop 130 provides the motor current command i_{cmd} and the dq current advance angle γ to the current control loop 140.

The current control loop 140 is operative to determine the voltage output signal vₒᵤₜ. As stated above, the voltage output signal vₒᵤₜ is indicative of the voltage to be supplied to each phase of the PMAC electric assist motor 50. The voltage output signal vₒᵤₜ is determined based at least partially on the current command i_{cmd}, the dq current advance angle γ, and the sensed rotor position θ. The voltage output signal vₒᵤ, is formatted to control PWM P W M of the FETs in the drive circuit 80 such that appropriate amounts of motor current iₘ, are provided to each phase of the electric motor 50. The measured motor current iₘₑₐₛ is provided to the motor control loop 130 and the current control loop 140.

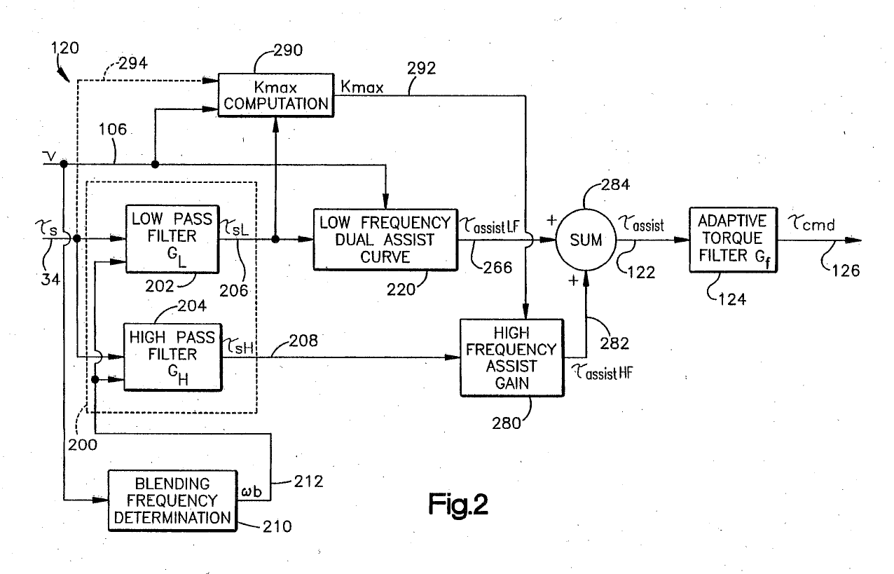

The torque control loop 120 is illustrated in FIG. 2. In this explanation, some of the functions performed by the ECU 70 are interchangeably referred to as functions or circuits. The sensed torque signal is provided to a blending filter 200 of the torque control loop 120. The blending filter 200 is designed by measuring the open loop transfer function Gₚ as a function of vehicle speed. The blending filter 200 is designed to meet stability and performance specifications for all, vehicle speeds v. The blending filter 200 is also designed to meet desired performance objectives, gain stability margins, and phase stability margins.

Specifically, the blending filter 200 includes a low pass filter (G_{L}) 202 and a high pass filter (G_{H}) 204. The low and high pass filters 202 and 204 are designed such that summation of the two filters is equal to one for all frequencies. The low pass filter 202 allows all of the sensed torque signal τₛ with frequency content below a blending frequency ω_{b} to pass through while rejecting all high frequency content of the signal. The high pass filter 204 allows all of the sensed torque signal τₛ with frequency content above the blending frequency ω_{b} to pass through while rejecting all low frequency content of the signal. The blending filter frequency ω_{b}, indicated at 212, is determined as a function of vehicle speed v by a blending filter determination function 210. The determination of ω_{b} may be accomplished using a look-up table in the ECU 70 or may be accomplished by performing a calculation in accordance with a predetermined equation.

The blending filters are chosen such that the sum of the low pass filter G_{L}(S) and the high pass filter G_{H}(S) is always equal to one:

G_{L}(S)+G_{H}(S)=1 (1)

In accordance with the example embodiment, the low pass filter 202 is chosen to be a first order filter with a pole at the blending frequency ω_{b}. The high pass filter 204 is uniquely defined by the above constraint that the sum of the two filters must be one.

Therefore, the low and high pass filters are:

$$\begin{matrix}{G}_{L} ( S ) = \frac{{ω}_{b}}{S + {ω}_{b}} & ( 2 ) \\ {G}_{H} ( S ) = \frac{S}{S + {ω}_{b}} & ( 3 )\end{matrix}$$

When realizing a set of blending filters in a digital computer, those skilled in the art will appreciate that it is not necessary, to construct separate high and low pass filter stages. Rather, the sensed torque signal τₛ input to the blending filters is passed through the low pass filter to obtain the low-passed torque signal τ_{sL}. The high-passed torque signal is the sensed torque τₛ minus the low-passed torque signal τ_{sL}. The low frequency portion τ_{sL} is thus subtracted from the sensed torque signal τₛ:

τ_{sH}=τₛ−τ_{sL} (4)

The result is a signal with only high frequency information. It will be appreciated that higher order blending filters may be used.

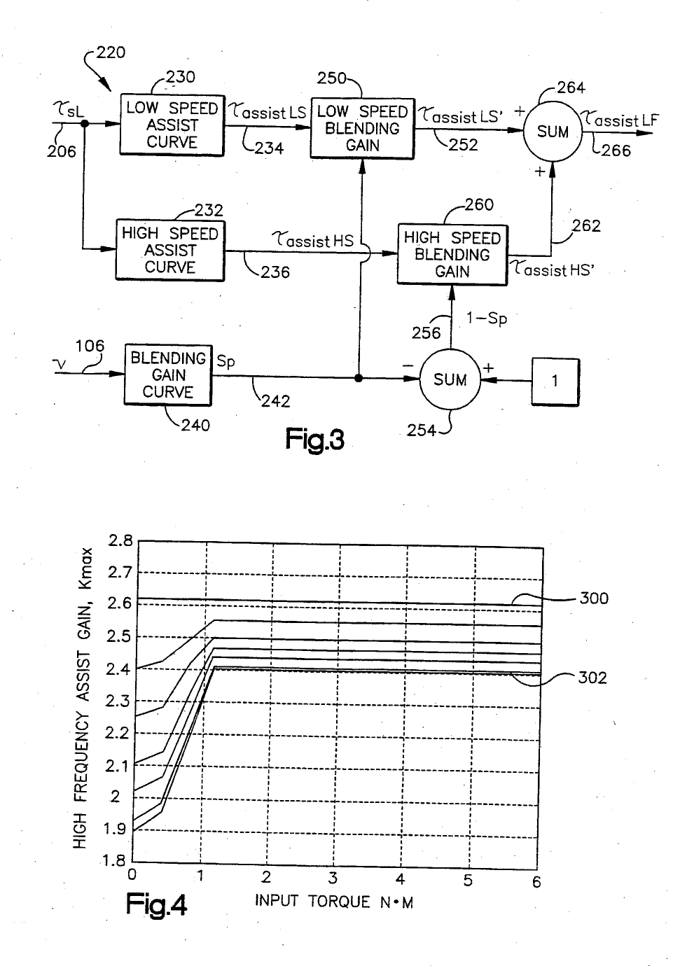

The low pass filter 202 provides a low-passed torque signal τ_{sL}, indicated at 206, to a low frequency dual assist curve circuit 220. The dual assist curve circuit 220 provides a low frequency assist torque signal τ_{assistLF} having a value functionally related to the low-passed torque signal τ_{sL} and the sensed vehicle speed v. The dual assist curve function 220 is illustrated in FIG. 3. The dual assist curve circuit 220 is illustrative of one method for determining the low frequency assist torque τ_{assistLF} based on the low-passed torque signal τ_{sL}. Those skilled in the art will appreciate that there are other methods for determining the low frequency assist torque τ_{assistLF} based on the low-passed torque signal τ_{sL}.

It will be appreciated that such other methods could replace the dual assist curve circuit 220 of the torque control loop 120 without departing from the spirit of the present invention. For example, a dual assist curve that may be used in accordance with the present invention is described in U.S. Pat. No. 5,568,389, issued to McLaughlin et al., to which reference is hereby directed.

The low-passed torque signal τ_{sL} is provided to a low-speed assist curve function 230, which provides a low-speed assist torque signal τ_{assistLS}, indicated at 234. The low-speed assist torque signal τ_{assistLS} represents an assist torque value intended for low or zero speed situations, such as vehicle parking. The low speed assist torque signal τ_{assistLS} is determined as a function of the low-passed torque signal τ_{sL}, which may be accomplished using a look-up table stored in the ECU 70 or may be accomplished by performing a calculation in accordance with a predetermined equation. The low speed assist curve typically has a deadband, wherein no assist is provided until the steering wheel torque exceeds a predetermined level. The deadband is required so that the steering wheel returns to center when released by the driver.

The low-passed torque signal τ_{sL} is also provided to a high-speed assist curve function 232, which provides a high-speed assist torque signal τ_{assistHS}, indicated at 236. The high-speed assist torque signal τ_{assistHS} represents an assist torque value intended for high speed vehicle operation, such as highway driving. The high-speed assist torque signal τ_{assistHS} is determined as a function of the low-passed torque signal τ_{sL}, which may be accomplished using a look-up table stored in the ECU 70 or may be accomplished by performing a calculation in accordance with a predetermined equation.

The vehicle speed signal v is provided to a blending gain curve circuit 240, which provides a speed proportional blending term or value Sₚ, indicated at 242. The speed proportional blending term Sₚ varies between zero and one as a function of vehicle speed. In the example embodiment, speed proportional blending term Sₚ varies between zero at high or maximum vehicle speeds and one at low or zero vehicle speed. The speed proportional blending term Sₚ is used to blend the low-speed assist torque τ_{assistLS} with the high-speed assist torque τ_{assistHS}.

The speed proportional blending term Sₚ and the low-speed assist torque τ_{assistLS} are provided to a low-speed blending gain circuit 250, which provides a blended low-speed assist torque signal τ_{assistLS}, indicated at 252. The low-speed blending gain circuit 250 multiplies the low-speed assist torque τ_{assistLS} by a low-speed blending gain value which is equal to the speed proportional blending term Sₚ.

The speed proportional blending term Sₚ is subtracted from one at a summation circuit 254 to determine a high-speed blending gain value 1-Sₚ, indicated at 256. The high-speed blending gain value 1-Sₚ and the high-speed assist torque τ_{assistHS} are provided to a high-speed blending gain circuit 260, which provides a blended high-speed assist torque signal τ_{assistHS}, indicated at 262. The high-speed blending gain circuit 260 multiplies the high-speed assist torque τ_{assistHS} by the high-speed blending gain value 1-Sᵣ. The sum of the low and high-speed blending gain values are thus always equal to one.

The blended low-speed assist torque signal τ_{assistLS} and the blended high-speed assist torque signal τ_{assistHS} are summed at a summing circuit 264 to provide a low frequency assist torque signal τ_{assistLF}, indicated at 266. The low frequency assist torque signal τ_{assistLF} is thus determined according to:

τ_{assistLF}=(Sₚ×τ_{assistLS})+((1−Sₚ)×τ_{assistHS}) (5)

and thus provides a smooth interpolation of the low and high-speed assist torque values τ_{assistLS} and τ_{assistHS} as vehicle speed v changes.

Referring to FIG. 2, the high-passed torque signal is provided to a high frequency assist gain circuit 280, which determines a high frequency assist signal τ_{assistHF}, indicated at 282. The high frequency assist signal τ_{assistHF} is added to the low frequency assist torque signal τ_{assistLF} at a summing circuit 284 to determine a torque assist signal τₐₛₛᵢₛₜ, indicated at 122.

The torque assist signal τₐₛₛᵢₛₜ may be filtered through an adaptive torque filter G_{f}, indicated at 124, to determine the motor command signal τ_{cmd}. An example of such an adaptive torque filter G_{f} is described in U.S. Pat. No. 5,473,231, issued to McLaughlin et al., to which reference is hereby directed.

The high frequency assist signal τ_{assistHF} is determined as the product of the high-passed torque signal τ_{sH} and a high frequency assist gain Kₘₐₓ. The high frequency assist gain Kₘₐₓ helps determine the bandwidth of the electric assist steering system 10. At high vehicle speeds, it is desirable to incorporate a relatively high value for the high frequency gain Kₘₐₓ in order to provide good off-center tracking. It is, however, also desirable, at high vehicle speeds, to incorporate a relatively low value for the high frequency gain Kₘₐₓ in order to provide good on-center feel. According to the present invention, the high frequency gain Kₘₐₓ is determined according to an algorithm that provides good off-center tracking and good on-center feel at high vehicle speeds.

The high frequency assist gain Kₘₐₓ, indicated at 292, is determined at a Kₘₐₓ, computation function 290. According to the present invention, the high frequency assist gain Kₘₐₓ is determined as a function of the vehicle speed v and the sensed torque signal τₛ. In the example embodiment of FIG. 2, the high frequency assist gain Kₘₐₓ is determined as a function of the vehicle speed v and the low-passed torque signal τ_{sL}. The high frequency assist gain Kₘₐₓ could, however, be determined as a function of the vehicle speed v and the sensed torque signal τₛ, as illustrated by the dashed line labeled 294 in FIG. 2. Of course, in this instance, it would not be necessary to provide the low-passed torque signal τ_{sL} to the Kₘₐₓ computation circuit 290.

The graph of FIG. 4 illustrates an example by which the high frequency assist gain Kₘₐₓ is determined as a function of the vehicle speed v and the input torque. It will be appreciated that this graph may change, depending on the particular vehicle platform and/or desired steering response characteristics. As stated above, the input torque may be the sensed torque signal or the low-passed torque signal τ_{sL}.

Referring to FIG. 4, the high frequency assist gain Kₘₐₓ for low or zero speed is defined by the curve indicated at 300. The high frequency assist gain Kₘₐₓ for high or maximum speed is defined by the curve indicated at 302. The curves spaced between the low-speed and high-speed high frequency assist curves 300 and 302 indicate the high frequency assist gain Kₘₐₓ at predetermined incremental variations in vehicle speed.

As indicated by the low-speed Kₘₐₓ curve 300, at low vehicle speeds, the high frequency assist gain Kₘₐₓ is constant, i.e., is the same regardless of the amount of input torque. The low-speed Kₘₐₓ curve 300 could, however, be adapted to provide a high frequency assist gain Kₘₐₓ that varies with the amount of input torque. As vehicle speed v increases, the high frequency assist gain Kₘₐₓ varies depending on the vehicle speed and the input torque, i.e., the low-passed torque τ_{sL}. In general, the high frequency assist gain Kₘₐₓ increases from a minimum value, depending on vehicle speed, as the input torque increases from zero N·M. The high frequency assist gain Kₘₐₓ increases at a generally low rate or slope from zero N·M to about 0.3 N·M. At about 0.3 N·M, the high frequency assist gain Kₘₐₓ increases at a higher rate or slope from 0.3 N·M to just over 1.0 N·M. At about just over 1.0 N·M, the high frequency assist gain Kₘₐₓ remains constant regardless of the amount of input torque.

The Kₘₐₓ computation circuit 290 determines the high frequency assist gain Kₘₐₓ in accordance with the curves illustrated in FIG. a. The computation may be accomplished using a look-up table stored in the ECU 70. Interpolation techniques may be used to determine the high frequency assist gain Kₘₐₓ when the vehicle speed v is between the predetermined speeds defined by the two closest speed curves. The Kₘₐₓ computation circuit 290 alternatively could determine the high frequency assist gain Kₘₐₓ by performing a calculation in accordance with a predetermined equation selected in accordance with the Kₘₐₓ curves in FIG. 4.

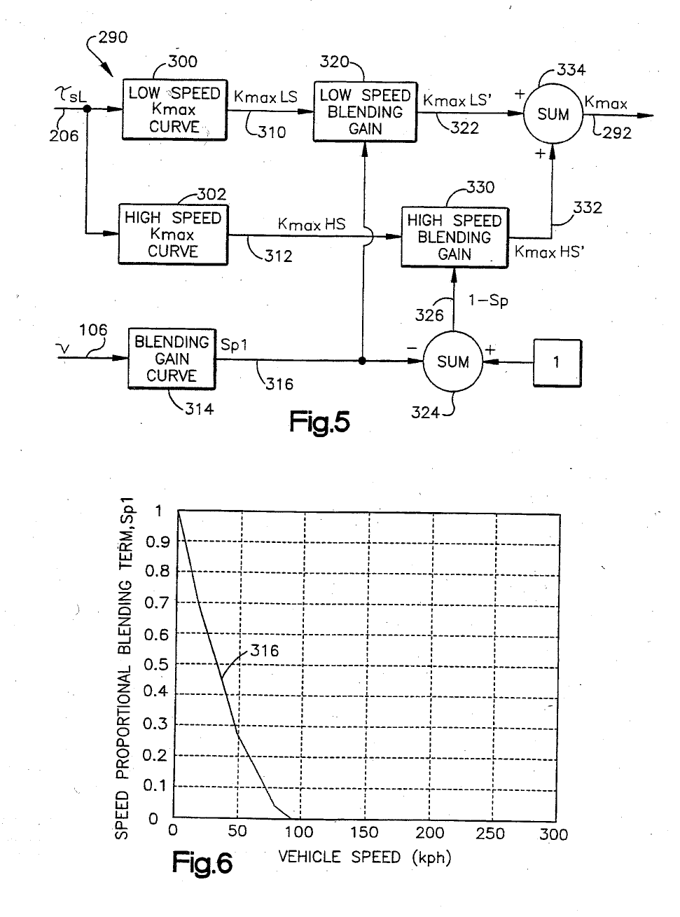

In another embodiment, the Kₘₐₓ computation circuit 290 performs a dual curve blending algorithm, similar to the algorithm incorporated in the low frequency dual assist curve circuit 220 (FIG. 3), to determine the high frequency assist gain Kₘₐₓ. In this instance, the low-speed Kₘₐₓ curve 300 (FIG. 4) is blended with the high-speed Kₘₐₓ curve 302 to determine the high frequency assist gain Kₘₐₓ. This is illustrated in FIG. 5.

Referring to FIG. 5, the low-passed torque signal 206 is provided to the low-speed Kₘₐₓ curve 300, which provides a low-speed high frequency assist gain K_{maxLS}, indicated at 310. The low-speed high frequency assist gain K_{maxLS} represents a high frequency assist gain value intended for low or zero vehicle speed situations, such as vehicle parking. The low speed high frequency assist gain K_{maxLS} is determined as a function of the low-passed torque signal τ_{sL}, which may be accomplished using a look-up table stored in the ECU 70 or may be accomplished by performing a calculation in accordance with a predetermined equation. The low-passed torque signal is also provided to the high-speed Kₘₐₓ curve 302, which provides a high-speed high frequency assist gain K_{maxHS}, indicated at 312. The high-speed high frequency assist gain K_{maxHS} represents a high frequency assist gain intended for high speed vehicle operation, such as highway driving. The high-speed high frequency assist gain K_{maxHS} is determined as a function of the low-passed torque signal τ_{sL}, which may be accomplished using a look-up table stored in the ECU 70 or may be accomplished by performing a calculation in accordance with a predetermined equation.

The vehicle speed signal v 106 is provided to a blending gain curve circuit 314, which provides a speed proportional blending term or value Sₚ₁. (also referred to as a foldback gain), indicated at 316. The speed proportional blending term Sₚ₁ varies between zero and one as a function of vehicle speed v, as illustrated by the graph of FIG. 6. As shown in FIG. 6, in the example embodiment, speed proportional blending term Sₚ₁, indicated at 316, varies between zero at high vehicle speeds and one at zero vehicle speed. The speed proportional blending term Sₚ₁ is used to blend the low-speed high frequency assist gain K_{maxLS} with the high-speed high frequency assist gain K_{maxHS}.

Referring to FIG. 5, the speed proportional blending term Sₚ₁ and the low-speed high frequency assist gain K_{maxLS} are provided to a low-speed blending gain function 320, which provides a blended low-speed high frequency assist gain K_{maxLS}′, indicated at 322. The low-speed blending gain circuit 320 multiplies the low-speed high frequency assist gain K_{maxLS} by a low-speed blending gain value which is equal to the speed proportional blending, term Sₚ₁.

The speed proportional blending term Sₒ is subtracted from one at a summation circuit 324 to determine a high-speed blending gain value 1-Sₚ₁, indicated at 326. The high-speed blending gain value 1-Sₚ₁ and the high-speed high frequency assist gain K_{maxHS} are provided to a high-speed blending gain circuit 330, which provides a blended high-speed high frequency assist gain K_{maxHS} indicated at 332. The high-speed blending gain circuit 330 multiplies the high-speed high frequency assist gain K_{maxHS} by the high-speed blending gain value 1-S_{D1}. The sum of the low and high-speed blending gain values are thus always equal to one.

The blended low-speed high frequency assist gain K_{maxLS}′ and the blended high-speed high frequency assist gain K_{maxHS} are summed at a summing circuit 334 to provide the calculated Kₘₐₓ 292. Kₘₐₓ is thus determined according to:

Kₘₐₓ=(Sₚ₁×K_{maxLS})+((I−Sₚ₁)×K_{maxHS}) (6)

and thus provides a smooth interpolation of the low and high-speed high frequency assist gain values K_{maxLS} and K_{maxHS} as vehicle speed v changes.

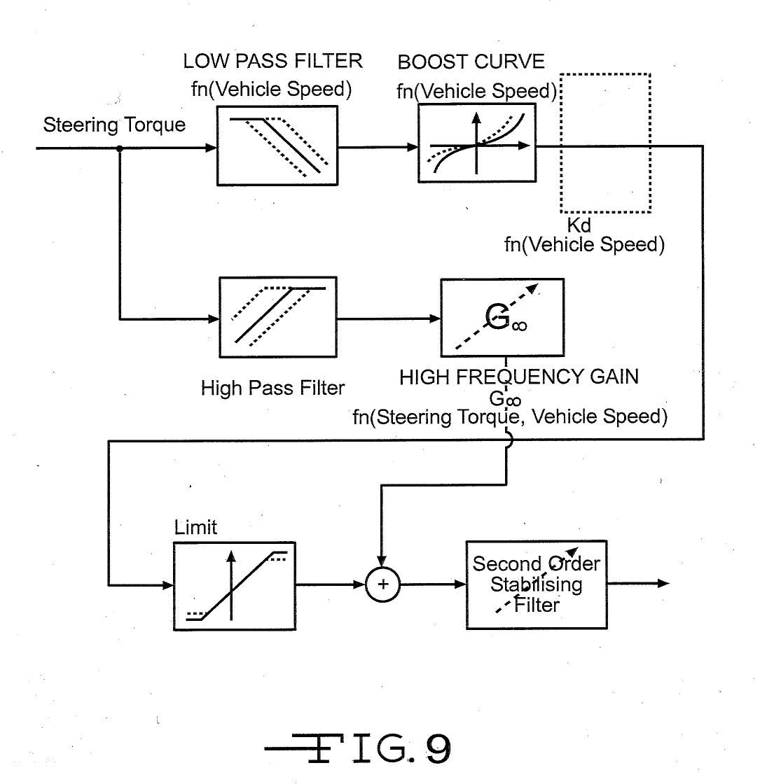

The high frequency assist gain Kₘₐₓ is determined based on both vehicle speed v and input torque S_{SL}. As illustrated by the Kₘₐₓ curves in FIG. 4 and FIG. 8, in general, the high frequency assist gain Kₘₐₓ increases as vehicle speed v decreases. Also, at any given speed, the high frequency assist gain Kₘₐₓ varies as a function of input torque S_{SL}. In general, for the particular Kₘₐₓ curves illustrated in FIG. 4, at any given speed (except zero speed where Kₘₐₓ is constant), the high frequency assist gain Kₘₐₓ is lower for low input torque values and higher for high input torque values. Therefore, at high vehicle speeds v, the high frequency assist gain Kₘₐₓ is adapted to provide good off-center tracking as well as goad on-center feel.

For input frequencies above the blending frequency ω_{b}, the torque control loop 120 is dominated by the high frequency assist gain portion 280 of the loop. Stability is easily analyzed and tested because the system behaves like a linear system near the zero crossover frequency. Since the blending frequency ω_{b} and the high frequency assist gain Kₘₐₓ are both functions of vehicle speed v, the system bandwidth of the electric assist steering system 10 can be controlled as a function of vehicle speed. This can be done by modifying the high frequency assist gain Kₘₐₓ via the speed proportional blending term Sₚ₁. The bandwidth decreases as the high frequency assist gain Kₘₐₓ decreases. Therefore, the high frequency portion of the torque control loop 120 defines the transient response and stability characteristics of the electric assist steering system 10.

For frequencies below the blending frequency ω_{b}, the torque control loop 120 is dominated by the low frequency dual assist curve portion 220 of the loop. This low frequency portion of the torque control loop 120 determines how the electric assist steering system 10 feels to the driver for slow, steady inputs. The dual assist curves may be tuned such that the electric assist steering system 10 provides a desired steering feel.

The amount of assist torque provided by the electric assist steering system 10 increases gradually as input torque (τₘₑₐₛ) increases away from the steering wheel torque dead-band. When coming off of the deadband, the local gain of the electric assist steering system 10 is generally very low, i.e., it takes a large change in input torque to produce a small change in steering assist torque. Without the high frequency assist gain portion 280 of the torque control loop 120, the overall system bandwidth would be reduced at low input torque and: the electric assist steering system 10 would feel sluggish. The inclusion of the high frequency assist gain portion 280 of the torque control loop 120, however, allows the system bandwidth to be selectable and causes the system to respond smoothly coming off of the deadband.

If the blending frequency ω_{b} is chosen a decade lower than the zero deadband crossover frequency, the non-linear low frequency dual assist curve portion 220 of the torque control loop 120 is a slowly varying phenomena when compared to the dynamics of the steering system. In essence, the non-linear low frequency portion is dynamically decoupled from the linear high frequency assist gain portion 280 of the torque control loop 120. The electric assist steering system 10 thus behaves in a non-linear fashion for low frequency inputs, and in a linear fashion for high frequency inputs.

Referring again to FIG. 5 one embodiment of the system described hereinbefore utilizes a “dual assist curve (DAC)” approach which generates two torque dependent curves, namely a low speed assist curve 300 and a high speed assist curve 302, and a speed dependent ratio (“speed pro”) 314. These elements combine to generate a high frequency assist curve (HFAC) whose gain Kₘₐₓ is a variable blend of low speed and high speed characteristics whereby at low vehicle speeds the low speed curve is predominant and at high vehicle speeds the high speed curve is predominant.

Thus, the “speed pro” 314 is used to determine the preponderance of each of the low and high speed curves at a given vehicle speed.

In the embodiment of FIG. 5, the “speed pro” is provided by the blending gain curve 314 which is responsive to vehicle speed alone to provide a speed proportional blending term Sₚ₁ on line 316.

However, the speed pro based on vehicle speed has the limitation in practice of slightly limiting the tuning freedom of the system, namely the balance between the desired characteristic wherein good on-centre feel requires a low value of high frequency gain Kₘₐₓ whereas good off-centre feel needs the high frequency gain Kₘₐₓ to have a high value.

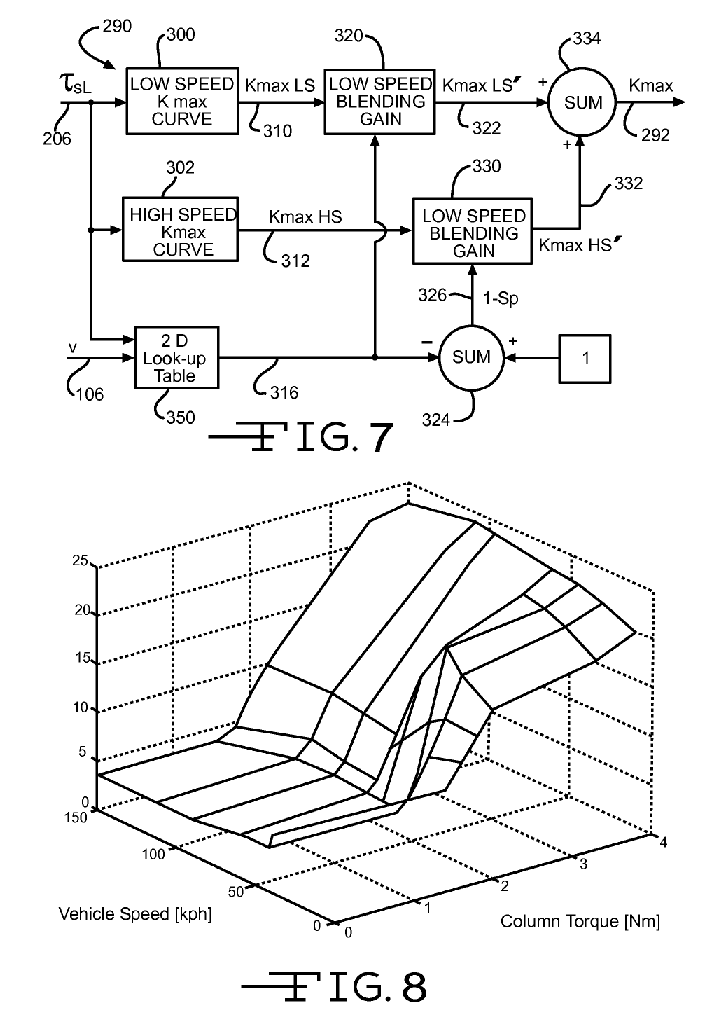

To overcome this limitation of the speed pro, in a further, preferred embodiment shown in FIG. 7, the speed pro/blending gain curve of FIG. 5 is replaced by a two-dimensional look-up table which has two inputs, namely vehicle speed and low frequency torque, and an output Kₘₐₓ. The latter arrangement is shown in FIG. 7 wherein parts which have the same function as in FIG. 5 are given the same reference numerals as in FIG. 5. The embodiment of FIG. 7 includes a two-dimensional map 350 having an input from line 106 carrying a signal v corresponding to the vehicle speed and an input from a line 206 carrying the low frequency torque signal T_{SL}, and an output Kₘₐₓ 292. Thus, in the preferred embodiment shown in FIG. 7, the Kₘₐₓ computation circuit 290 performs a two-dimensional linearly-interpolated map look-up function to determine the high frequency gain Kₘₐₓ. The two-dimensional look-up table 350 is stored in the ECU 70. The high frequency assist algorithm 280 generates the high frequency assist torque signal τ_{assistHF} 282 by forming the product of Kₘₐₓ 292 and the high-pass filtered torque signal τ_{SH}, 208. An example of a possible 2D map 350 is shown in FIG. 8.

A block diagram of the overall system incorporating the modifications of FIGS. 7 and 8 is shown in FIG. 9.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1-21. (canceled)

22. A method for controlling an electric assist motor for providing steeling assist in response to a sensed torque signal, said method comprising the steps of:
filtering the sensed torque signal to provide a low frequency torque signal and a high frequency torque signal;
determining a low frequency assist torque signal as a function of the low frequency torque signal;
determining a high frequency assist torque signal as a function of the sensed torque signal and a sensed vehicle speed;
applying the high frequency assist gain signal to the high frequency torque signal to determine a high frequency assist torque signal;
determining a torque command signal as a function of the low frequency assist torque signal; and
commanding the electric assist motor to provide steering assist in accordance with a voltage output signal, the voltage output signal being functionally related to the torque command signal.

23. The method according to claim 22 wherein the high frequency gain signal is determined with a two-dimensional linearly-interpolated map function as a function of the sensed torque signal and the sensed vehicle speed.

24. The method according to claim 23 in which the two-dimensional linearly-interpolated map function receives as its inputs the low frequency torque signal and the sensed vehicle speed.

25. The method according to claim 24, wherein the step of filtering provides the low frequency torque signal having frequencies below a blending frequency, and provides the high frequency torque signal having frequencies above the blending frequency.

26. The method according to claim 25, further including a step of determining the blending frequency as a function of the sensed vehicle speed.

27. The method according to claim 26, wherein the step of determining the low frequency assist torque signal includes the sub-steps of:
providing dual assist curves; and
performing a blending algorithm to blend the dual assist curves to provide the low frequency assist torque signal.

28. The method according t claim 27, wherein the step of applying the high frequency assist gain signal includes determining a product of the high frequency torque signal and the high frequency assist gain signal.

29. A method according to any of claim 28, wherein the step of determining a torque command signal includes the sub-steps of:
determining a sum of the low frequency assist torque signal and the high frequency assist torque signal; and
filtering the sum of the low frequency assist torque signal and the high frequency assist torque signal through an adaptive torque filter.

30. An apparatus for controlling a vehicle electric assist steering motor, said apparatus comprising:
a vehicle speed sensor that is operative to provide a speed signal having a value indicative of a sensed vehicle speed;
an applied steering torque sensor that is operative to provide a sensed torque signal indicative of an applied steering torque;
a filter that is operative to filter the sensed torque signal to provide a low frequency torque signal and a high frequency torque signal;
a dual assist curve circuit that is operative to determine low frequency assist torque value as a function of said low frequency torque signal and to provide a low frequency assist torque signal indicative thereof;
a computation circuit that is operable to determine a high frequency assist gain value as a function of said sensed torque signal (rₑ) and a sensed vehicle speed (v) and providing a high frequency assist gain signal indicative thereof
a high frequency assist circuit that is operable to determine a high frequency assist torque value related to the product of said high frequency torque signal and said high frequency assist gain signal and to provide a high frequency assist torque signal indicative thereof;
a device that is operative to determine a torque command value as a function of said low frequency assist torque signal and said high frequency assist torque signal and for providing a torque command signal indicative thereof; and
a motor controller that is operative to command the electric assist motor to provide steering assist in accordance with said torque command signal.

31. The apparatus according to claim 30 wherein said computation circuit includes a two-dimensional, linearly-interpolated map function.

32. The apparatus according to claim 31, wherein said filter includes a low pass filter for passing frequencies of the sensed torque single that are below a blending frequency, and a high-pass filter for passing frequencies of the sensed torque single that above said blending frequency.

33. The apparatus according to claim 32, wherein said blending frequency is selected as a function of said sensed vehicle speed:

34. The apparatus according claim 33, wherein said device that is operative to determine a torque command value includes:
a summing circuit that is operative to determine a sum of said low frequency assist torque signal and said high frequency assist torque signal; and
an adaptive torque filter that is operative to filter said sum of said low frequency assist torque signal and said high frequency assist torque signal.

35. The apparatus according claim 34 further including an electronic control unit which stores said two-dimensional linearly-interpolated map function.

36. The apparatus according claim 35, wherein which said two-dimensional linearly-interpolated map function receives as its inputs said low frequency torque signal and said sensed vehicle speed.
